(19) United States
(12) Patent Application Publication
(10) Pub. No.: US 2026/0168799 A1
(43) Pub. Date: Jun. 18, 2026

(54) SYSTEM AND METHOD FOR GENERATING TRIP DATA BASED ON TRAJECTORY DATA

(71) Applicant: HERE Global B.V., Eindhoven (NL)

(72) Inventors: Jingwei XU, Buffalo Grove, IL (US); Weimin HUANG, Chicago, IL (US); Yuxin GUAN, Chicago, IL (US)

(21) Appl. No.: 18/986,223

(22) Filed: Dec. 18, 2024

(51) Int. Cl. G01C 21/34

(52) U.S. Cl. CPC G01C 21/3438

(57) ABSTRACT

A system for generating trip data based on trajectory data is disclosed. The system obtains trajectory data associated with a trajectory of a vehicle. The system further determines event data associated with a stop event of the trajectory based on the trajectory data. The system further determines a stop time period associated with the stop event based on the event data. The stop time period includes a first time instance corresponding to a start of the stop event and a second time instance corresponding to an end of the stop event. The system further generates trip data associated with at least one of a first trip or a second trip based on the stop time period. The system further outputs the trip data associated with the trajectory.

### TECHNOLOGICAL FIELD

The present disclosure generally relates to a system for generating trip data, and more particularly relates to a system and a method for generating trip data based on trajectory data of ride-sharing vehicles.

### BACKGROUND

In map navigation systems, trips processing systems play a crucial role in providing non-real time traffic analytics for use cases in transportation and logistics, navigation, routing, points of interest (POI), and road network planning. Moreover, traffic processing systems provide real time traffic conditions on road segments. For traffic and trips processing, probe data is usually acquired from ride-sharing fleet vehicles, which provides geolocation data to enhance navigation and dynamic content services.

The ride-sharing fleet vehicles may provide probe data indicating overall flow of traffic in which they have travelled that do not reflect real time traffic flow. Accordingly, using such probe data for traffic processing in the traffic processing systems may result in inaccurate real-time traffic flow determinations. Additionally, data privacy regulations require that origin and destination-related geolocations in the probe data are obfuscated, due to which use of the probe data by trips processing systems may also result in inaccuracies in trip analytics.

Therefore, integrating the probe data directly into the traffic processing systems and/or trips processing systems leads to inaccurate results in trip analytics and traffic assessments. This calls for a need for techniques for improving or updating the probe data to integrate the probe data into the traffic processing systems and/or trips processing systems.

### BRIEF SUMMARY OF SOME EXAMPLE EMBODIMENTS

The present disclosure provides methods and systems that enable seamless utilization of ride-sharing probe data into trips processing systems. To this end, some embodiments provide machine learning (ML) based model to detect stop events in probe data. These stops events are classified as corresponding to a traffic label or a non-traffic label to efficiently utilize the ride-sharing probe data into the traffic processing systems or the trips processing systems. According to the present disclosure, stop events classified with non-traffic label may be used by trips processing systems for generating trips analytics. Accordingly, the present disclosure addresses a problem of inaccurate results in trips processing and trips analytics due to obfuscated trip data.

By analyzing the probe data of ride-sharing vehicles, the trip data may be generated to display most common or heavily used routes, efficient routes, congested areas, and optimal departure times, thereby improving navigation and planning across various origins and destinations. Furthermore, efficient route planning based on the trip data may also lead to reduced costs and emissions by minimizing idling times and unnecessary detours, contributing to a lower carbon footprint.

A system, a method, and a computer programmable product are provided for implementing the process for generating trip data based on trajectory data.

In one aspect, a system for generating trip data based on trajectory data is disclosed. The system includes a memory configured to store computer executable instructions and one or more processors configured to obtain trajectory data associated with a trajectory of a vehicle. The one or more processors are further configured to determine event data associated with a stop event of the trajectory based on the trajectory data. The one or more processors are further configured to determine a stop time period associated with the stop event based on the event data. The stop time period comprises a first time instance corresponding to a start of the stop event and a second time instance corresponding to an end of the stop event. Further, the one or more processors are configured to generate trip data associated with at least one of a first trip, or a second trip based on the stop time period. The first trip is associated with a first time period occurring before the first time instance and the second trip is associated with a second time period occurring after the second time instance. The one or more processors are further configured to output the trip data associated with the trajectory.

In additional system embodiments, the stop event is associated with a non-traffic label.

In additional system embodiments, the trajectory includes a plurality of datapoints. The trajectory data includes at least one of: a speed value associated with each datapoint of the plurality of datapoints, location data associated with each datapoint of the plurality of datapoints, and timestamp data associated with each datapoint of the plurality of datapoints.

In additional system embodiments, the one or more processors are further configured to input the trajectory data to a trained Machine Learning (ML) model. The ML model is trained to partition the plurality of datapoints based on the speed value and the location data. Further, the one or more processors are configured to generate, using the trained ML model, a cluster based on the speed value and the location data. The cluster includes at least one datapoint of the plurality of datapoints. The cluster corresponds to the stop event.

In additional system embodiments, the one or more processors are further configured to obtain map data including information associated with a plurality of reference locations. The one or more processors are further configured to determine center location data for the cluster. The one or more processors are further configured to associate the cluster with a reference location of the plurality of reference locations based on the center location data and the map data. Further, the one or more processors are configured to associate the stop event with one of a traffic label, or a non-traffic label based on the reference location associated with the cluster.

In additional system embodiments, the reference location associated with the cluster is associated with a geographical landmark, and the one or more processors are further configured to associate the stop event with the non-traffic label based on the geographical landmark.

In additional system embodiments, the one or more processors are further configured to obtain vehicle navigation data including a source location and a destination location. The at least one of: the source location, or the destination location is associated with at least one of: the first trip, or the second trip. The one or more processors are further configured to generate a navigation recommendation based on the vehicle navigation data and the trip data. The one or more processors are further configured to generate navigation instructions based on the navigation recommendation.

In additional system embodiments, the one or more processors are further configured to pre-process the trajectory data to remove one or more anomalies in the trajectory data.

In additional system embodiments, the one or more processors are further configured to receive the trajectory data from one or more sensors associated with the vehicle. The one or more sensors includes at least one of a Global Navigation Satellite System (GNSS) sensor, or a speed sensor.

In another aspect, a method of generating trip data based on trajectory data is disclosed. The method includes obtaining trajectory data associated with a trajectory of a vehicle. The method further includes determining event data associated with a stop event of the trajectory based on the trajectory data. The method further includes determining a stop time period associated with the stop event based on the event data. The stop time period includes a first time instance corresponding to a start of the stop event and a second time instance corresponding to an end of the stop event. Further, the method includes generating trip data associated with at least one of a first trip, or a second trip based on the stop time period. The first trip is associated with a first time period occurring before the first time instance and the second trip is associated with a second time period occurring after the second time instance. The method further includes outputting the trip data associated with the trajectory.

In additional method embodiments, the stop event is associated with a non-traffic label.

In additional method embodiments, the trajectory includes a plurality of datapoints, and the trajectory data includes at least one of a speed value associated with each datapoint of the plurality of datapoints, location data associated with each datapoint of the plurality of datapoints, and timestamp data associated with each datapoint of the plurality of datapoints.

In additional method embodiments, the method further includes inputting the trajectory data to a trained Machine Learning (ML) model. The ML model is trained to partition the plurality of datapoints based on the speed value and the location data. Further, the method includes generating, using the trained ML model, a cluster based on the speed value and the location data. The cluster includes at least one datapoint of the plurality of datapoints. The cluster corresponds to the stop event.

In additional method embodiments, the method further includes obtaining map data including information associated with a plurality of reference locations. The method further includes determining center location data for the cluster. The method further includes associating the cluster with a reference location of the plurality of reference locations based on the center location data and the map data. Further, the method includes associating the stop event with one of a traffic label, or a non-traffic label based on the reference location associated with the cluster.

In additional method embodiments, the reference location associated with the cluster is associated with a geographical landmark, and the method further includes associating the stop event with the non-traffic label based on the geographical landmark.

In additional method embodiments, the method further includes obtaining vehicle navigation data including a source location and a destination location. The at least one of the source location, or the destination location is associated with at least one of the first trip, or the second trip. The method further includes generating a navigation recommendation based on the vehicle navigation data and the trip data. The method further includes generating navigation instructions based on the navigation recommendation.

In additional method embodiments, the method further includes pre-processing the trajectory data to remove one or more anomalies in the trajectory data.

In yet another aspect, a computer program product comprising a non-transitory computer readable medium having stored thereon computer executable instructions which when executed by at least one processor, cause the processor to carry out operations for generating trip data based on trajectory data. The operations include obtaining trajectory data associated with a trajectory of a vehicle. The operations further include determining event data associated with a stop event of the trajectory based on the trajectory data. The operations further include determining a stop time period associated with the stop event based on the event data. The stop time period includes a first time instance corresponding to a start of the stop event and a second time instance corresponding to an end of the stop event. Further, the operations include generating trip data associated with at least one of a first trip, or a second trip based on the stop time period. The first trip is associated with a first time period occurring before the first time instance and the second trip is associated with a second time period occurring after the second time instance. The operations further include outputting the trip data associated with the trajectory.

In additional computer program product embodiments, the trajectory includes a plurality of datapoints, and the trajectory data includes at least one of a speed value associated with each datapoint of the plurality of datapoints, location data associated with each datapoint of the plurality of datapoints, and timestamp data associated with each datapoint of the plurality of datapoints.

In additional computer program product embodiments, the operations further include inputting the trajectory data to a trained Machine Learning (ML) model. The ML model is trained to partition the plurality of datapoints based on the speed value and the location data. Further, the operations include generating, using the trained ML model, a cluster based on the speed value and the location data. The cluster includes at least one datapoint of the plurality of datapoints. The cluster corresponds to the stop event.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a network environment in which a system for generating trip data based on trajectory data is implemented, in accordance with an embodiment of the disclosure;

FIG. 2 illustrates a block diagram of the system of FIG. 1, in accordance with an embodiment of the disclosure;

FIG. 3A illustrates a flowchart of an exemplary method for generating one or more clusters corresponding to one or more stop events using a machine learning (ML) model, in accordance with an embodiment of the disclosure;

FIG. 3B illustrates a graphical representation of a cluster associated with a stop event, in accordance with an embodiment of the disclosure;

FIG. 4 illustrates a flowchart of an exemplary method for associating one or more stop events with traffic label or non-traffic label, in accordance with an embodiment of the disclosure;

FIG. 5A illustrates a flowchart of an exemplary method for generating navigation instructions, in accordance with an embodiment of the disclosure;

FIG. 5B illustrates a schematic diagram of a trajectory of a vehicle including one or more stop events, in accordance with an embodiment of the disclosure;

FIG. 6 illustrates a flowchart of an exemplary method for generating trip data based on trajectory data, in accordance with an embodiment of the disclosure;

FIG. 7 illustrates an exemplar record of map data stored in map database, in accordance with one or more example embodiments;

FIG. 8 illustrates another exemplar record of map data stored in map database, in accordance with one or more example embodiments; and

FIG. 9 illustrates a block diagram of the map database storing map data, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one referenced item of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

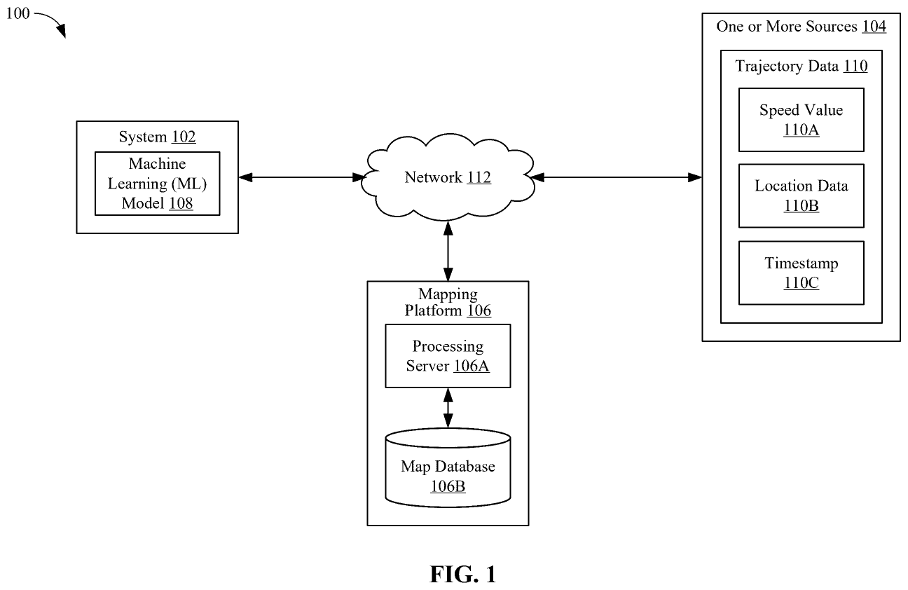

FIG. 1 illustrates a network environment 100 in which a system 102 for generating trip data based on trajectory data is implemented, in accordance with an embodiment of the disclosure. The network environment 100 includes the system 102, one or more sources 104, a mapping platform 106, a ML model 108, and a network 112. The mapping platform 106 may further include a processing server 106A, and a map database 106B. The one or more sources 104 may be, for example, but not limited to, a map database 106B, one or more sensors onboard a ride-sharing vehicle, or any other database associated with the ride-sharing vehicle. The one or more sources 104 may further provide trajectory data 110 associated with a trajectory of a vehicle. The trajectory data 110 may further include a speed value 110A, location data 110B, and a timestamp 110C.

It is expected that the market for ride-sharing vehicles will grow significantly in upcoming years. As a result, using ride-sharing probe data to identify trips may be beneficial in providing more targeted and centralized map services, specifically, to users who tend to use the ride-sharing vehicles for their travel purposes. To generate the trip data, it is necessary to determine origin locations and destination locations within a trajectory. However, a problem associated with a trajectory acquired from ride-sharing vehicles is that origin locations and destination locations are obfuscated in the trajectory to ensure security standards. Therefore, to solve the aforementioned problem, the system 102 is configured to identify stop events which are not associated with the traffic incidents, and further determine the origination locations and the destination locations within the trajectory based on the stop events. Accordingly, association or classification of the stop events with the traffic label or the non-traffic label is necessary to identify stop events which are associated with the non-traffic incidents. Such non-traffic stop events are used to generate trip data associated with the trajectory. Further, the generated trip data may be used to display most efficient routes, congested areas, and optimal departure times, on user devices, thereby helping users save time and reduce travel stress. Further, the trip data may also be used to help users save on fuel costs by suggesting more fuel-efficient routes. Furthermore, efficient route planning based on the trip data may also lead to reduced vehicle emissions by minimizing idling times and unnecessary detours, thereby contributing to a lower carbon footprint.

The system 102 may include suitable logic, circuitry, interfaces, and/or code that may be configured to generate the trip data based on the trajectory data 110. Examples of the system 102 may include, but are not limited to, an electronic control unit (ECU), an electronic control module (ECM), a computing device, a mainframe machine, a server, a computer workstation, any and/or any other device with trip data generation operations.

In operation, the system 102 is configured to obtain the trajectory data 110 associated with a trajectory of the vehicle. In an example, the vehicle may be a ride-sharing vehicle and the trajectory data 110 may be ride-sharing probe data received from the ride-sharing vehicle. Further, the trajectory of the vehicle may be a pathway travelled by the vehicle from an origination location to a destination location in a time duration of, for example, 30 minutes, 1 hour, 5 hours, 8 hours, 12 hours, 24 hours, and the like. The vehicle may be a non-autonomous vehicle, a semi-autonomous vehicle, or a fully autonomous vehicle, for example, as defined by National Highway Traffic Safety Administration (NHTSA). Examples of the vehicle may include, but are not limited to, a two-wheeler vehicle, a three-wheeler vehicle, a four-wheeler vehicle, more than four-wheeler vehicle, a hybrid vehicle, or a vehicle with autonomous drive capability that uses one or more distinct renewable or non-renewable power sources.

A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may be a system through which an occupant (for example a rider) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car.

In an embodiment, the trajectory comprises a plurality of datapoints, and the trajectory data 110 comprises the speed value 110A associated with each datapoint of the plurality of datapoints, the location data 110B associated with each datapoint of the plurality of datapoints, and/or the timestamp 110C associated with each datapoint of the plurality of datapoints. Each datapoint of the plurality of datapoints may refer to a specific location from where the probe data is transmitted by the vehicle or the specific location at which information associated with vehicle may be extracted for analysis. The probe data includes information collected from vehicles equipped with at least a Global Positioning Systems (GPS). These vehicles act as probes, and transmit data such as location, speed, and timestamp, for example. In the context of trips analytics, the plurality of datapoints may refer to specific locations on the trajectory from where the plurality of datapoints may be collected to generate the trajectory data 110. In an example embodiment, the system 102 may be configured to obtain the trajectory data 110 from the map database 106B.

In an embodiment, the vehicle may be the ride-sharing vehicle, and may be equipped with one or more sensors configured to sense the trajectory data 110. Further, the sensed trajectory data 110 may be transmitted by the one or more sensors to a database associated with the ridesharing vehicle service provider. In such embodiment, the system 102 may be configured to obtain the trajectory data 110 from the database associated with the ridesharing vehicle service provider. In another embodiment, the trajectory data 110 sensed by the one or more sensors equipped in the vehicle may be stored in a database associated with the vehicle. In such embodiment, the system 102 may be configured to obtain the trajectory data 110 from the database associated with the vehicle. In one more embodiment, the system 102 may be configured to receive the trajectory data 110 from the one or more sensors associated with the vehicle. The one or more sensors may include a Global Navigation Satellite system (GNSS) sensor, and/or a speed sensor.

Further, the system 102 is configured to determine event data associated with a stop event of the trajectory based on the trajectory data 110. In one example, the stop event occurred on the trajectory when the vehicle stopped at a specific location or when a speed of the vehicle is less than a threshold at the specific location. In an exemplary embodiment, the event data associated with the stop event may include a set of datapoints from the plurality of datapoints. For example, considering the trajectory includes the plurality of datapoints and each datapoint of the plurality of datapoints is associated with a speed value from the speed value 110A, the event data may include data associated with the set of datapoints having corresponding speed value as 0 kilometers per hour (km/h) or less than the threshold. The threshold may be, for example, 3 km/h, 5 km/h, or the like. Further, each datapoint of the set of datapoints may be indicative of a speed of the vehicle at a corresponding location. The location data 110B of each datapoint of the set of datapoints may be indicative of specific locations when the vehicle stopped and/or slowed down below the threshold. The timestamp 110C of each datapoint of the set of datapoints may be indicative of a time instant of the vehicle when the vehicle stopped at the specific location.

Further, the system 102 is configured to determine a stop time period associated with the stop event based on the event data. In an example, the stop time period is indicative of a time range in which the vehicle stopped and/or slowed down below the threshold at specific locations of the stop event on the trajectory. The stop time period may be, for example, 10 minutes, 20 minutes, 1 hour, and the like. The stop time period may include a first time instance corresponding to a start of the stop event, and a second time instance corresponding to an end of the stop event. In an example, the first time instance may be associated with a first timestamp and the second time instance may be associated with a second timestamp. In the present example, the first timestamp may be indicative of ‘01 hour: 05 minutes: 00 seconds’ and the second timestamp may be indicative of ‘01 hour: 15 minutes: 00 seconds’. Accordingly, the stop time period for the stop event may be determined as a time difference between the timestamp ‘01:15:00’, and the timestamp ‘01:05:00’, which is 10 minutes in the present example. Further, the first time instance may correspond to ‘01:05:00’ and the second time instance may correspond to ‘01:15:00’.

Further, the system 102 is configured to generate trip data associated with at least one of a first trip, or a second trip based on the stop time period. In an example, each of the first trip and the second trip may be a part of the trajectory of the vehicle, i.e., a sub-trajectory, including a source location and a destination location. The generation of the trip data corresponding to at least one of the first trip or the second trip may include an identification of the first trip and the second trip based on the determined stop time period. In an example, the first trip is associated with a first time period occurring before the first time instance and the second trip is associated with a second time period occurring after the second time instance.

In an example, the first time instance corresponds to a start of the stop event and the second time instance corresponds to an end of the stop event. Further, the first trip may be identified as a sub-trajectory of the trajectory including a first origin location and a first destination location. For example, the first origin location may be a random location of the trajectory or may correspond to another stop event previous to a current stop event under consideration. Further, the first destination location may be associated with a location of the stop event under consideration. Similarly, the second trip may be identified as another sub-trajectory of the trajectory including a second origin location and a second destination location. For example, the second origin location may be associated with the location of the stop event under consideration while the second destination location may be a random location of the trajectory or may correspond to another stop event subsequent to the current stop event under consideration.

Specifically, in one example, the trajectory may be split in a manner that the first trip may end at a center location of the stop event and the second trip may start at the center location of the stop event. Further, the trip data of the first trip and/or the second trip may include information indicative of a dwell time associated with the first destination location and/or the second destination location of the first trip and/or the second trip, and a departure time associated with the first trip and/or the second trip. In an example, the dwell time may indicate an operation of standstill at the location of the stop event. Specifically, the dwell time may be indicative of the determined stop time period associated with the stop event. In another example, the departure time may indicate an operation of reaching the destination location from the source location. In particular, the departure time of the first trip may be indicative of a time range in which the vehicle reached the first destination location and/or the second destination location from the corresponding origin location.

Further, the system 102 is configured to output the generated trip data. In an embodiment, the system 102 may be configured to output the generated trip data to downstream applications, such as a trips processing system. In an example, the trips processing may include updating the map database 106B based on the generated trip data. In another embodiment, the system 102 may be configured to output the generated trip data to user devices associated with users that may be planning to travel along the trajectory or a part thereof. Consider an example where a user is travelling on a sub-trajectory of the first trip and a destination of the user is identical to the first destination location of the first trip. In such an example, the departure time associated with the first trip may be provided to the user, such as via a user device of the user to notify the user regarding a time to reach the destination.

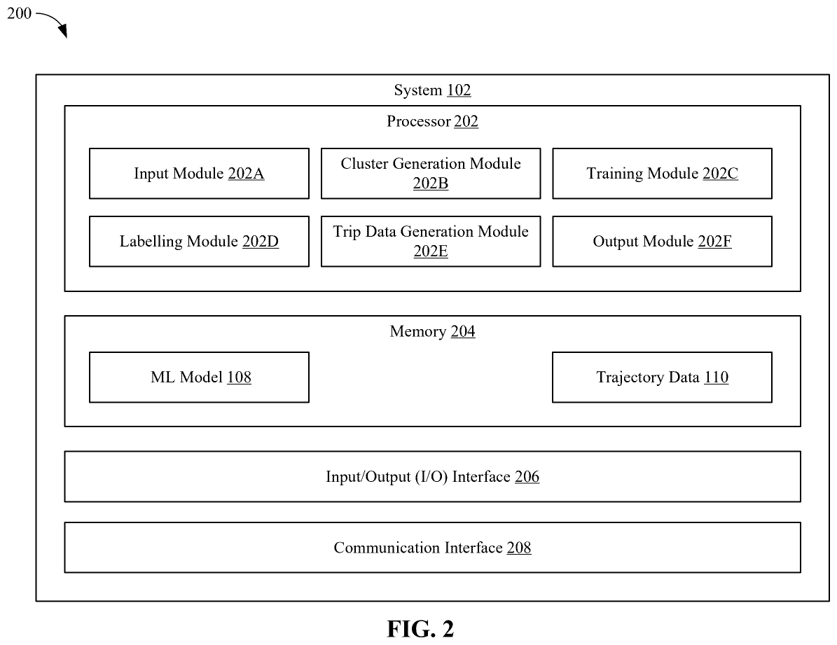

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may comprise modules, depicted as, an input module 202A, a cluster generation module 202B, a training module 202C, a labelling module 202D, a trip data generation module 202E, and an output module 202F. The circuitry 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A, and the output module 202F may be integrated within the I/O interface 206. In some embodiments, the input module 202A may receive input data (such as user inputs) and the output module 202F may output processed data (such as the one or more clusters, trip data, and the like) via the I/O interface 206.

In accordance with an embodiment, the system 102 may store data that may be generated by the modules while performing corresponding operations or may be retrieved from a database associated with the system 102, such as the map database 106B, in the memory 204. For example, the data may include trajectory data 110, trip data, speed value 110A, location data 110B, and timestamp 110C.

The processor 202 of the system 102 may be configured to obtain the trajectory data 110, apply the machine learning model 108, generate a cluster, and output the generated cluster. The input module 202A of the processor 202 may be configured to obtain the trajectory data 110 associated with the trajectory of the vehicle. In one embodiment, the input module 202A may be configured to receive the trajectory data 110 from the one or more sensors associated with the vehicle. In one example, the one or more sensors are included in the vehicle to receive the trajectory data 110. In another example, the one or more sensors may be installed in the vicinity of the trajectory to obtain the trajectory data 110 associated with the vehicles. For example, the one or more sensors may include one or more image sensors, one or more LIDARs, one or more speed sensors, one or more global positioning sensors (GPS), the Global Navigation Satellite System (GNSS) sensor, or the speed sensor and the like. Further, the input module 202A may be configured to transmit the trajectory data 110 to the cluster generation module 202B.

The cluster generation module 202B of the processor 202 may be configured to apply the ML model 108 on the trajectory data 110. The obtained trajectory data 110 may be associated with the trajectory of the vehicle. In an exemplary embodiment, the trajectory may include a plurality of datapoints, and the trajectory data 110 may include the speed value 110A, the location data 110B, and the timestamp 110C at which the trajectory data may be acquired. The cluster generation module 202B may be configured to analyze the speed value 110A associated with each datapoint of the plurality of datapoints, and based on the analysis, the cluster generation module 202B may be further configured to generate one or more set of datapoints from the plurality of datapoints. Specifically, to generate a cluster of one or more clusters, the ML model 108 may be configured to determine whether the speed value 110A associated with each datapoint of the plurality of datapoints is less than a threshold. The threshold may be, for example, but not limited to 3 km/h, or 5 km/h. In an example, each datapoint of a set of datapoints of the one or more set of datapoints may be indicative of the speed value 110A less than the threshold. In an embodiment, each set of datapoints of the one or more set of datapoints may correspond to a stop event of one or more stop events. The cluster generation module 202B may be further configured to transmit information associated with the generated one or more clusters to the labelling module 202D.

The training module 202C of the processor 202 may be configured to train the ML model 108 to generate the one or more clusters. In an embodiment, the training module 202C of the processor 202 may be configured to re-train the ML model 108 in certain iterations to improve accuracy of the generation of the one or more clusters. In an embodiment, the training module 202C trains the ML model 108 to employ machine learning algorithms and techniques to analyze the speed value 110A associated with each datapoint of the plurality of datapoints, and further generate the one or more clusters based on the analysis.

The labelling module 202D of the processor 202 may be configured to associate the stop event with the traffic label or the non-traffic label. In particular, the labelling module 202D may be configured to determine whether a reference location associated with the stop event corresponds to one of the signalized intersection, the non-signalized intersection, the road segment, or the POI. Further, the labelling module 202D may be configured to associate the stop event with the traffic label based on the determination that the reference location of the stop event corresponds to one of the signalized intersection, the non-signalized intersection, or the road segment between road segments. Alternatively, the system 102 is configured to associate the stop event with the non-traffic label based on the determination that the reference location of the stop event corresponds to the POI. The labelling module 202D may be further configured to transmit the labeled stop event to the trip data generation module 202E.

The trip data generation module 202E of the processor 202 may be further configured to generate the trip data based on the stop event associated with the non-traffic label. In order to generate the trip data, the trip data generation module 202E is configured to analyze the generated cluster of the stop event. For example, if the stop event corresponds to a POI, then the stop event may be labelled with the non-traffic label.

In one embodiment, based on a single stop event may be occurred on the trajectory and the stop event is associated with the non-traffic label, the first trip and the second trip may be generated. For example, the first trip may include a starting location of the trajectory as the origination location, and the reference location associated with the stop event as the destination location. Similarly, the second trip may include the reference location associated with the stop event as the origination location and an ending location of the trajectory as the destination location. In an example, the starting location of the trajectory may be a location associated with a first datapoint of the plurality of datapoints of the trajectory, and the ending location of the trajectory may be a location associated with a last datapoint of the plurality of datapoints of the trajectory.

In another example, if two stop events associated the non-traffic label are determined on the trajectory, the system 102 may be configured to generate three trips including the first trip, the second trip, and a third trip. Specifically, the first trip may include the starting location of the trajectory as the origination location, and the reference location associated with a first stop event of the two stop events as the destination location. Further, the second trip may include the reference location associated with the first stop event as the origination location and the reference location associated with a second stop event of the two stop events as the destination location. Similarly, the third trip may include the reference location associated with the second event as the origination location and the ending location of the trajectory as the destination location. In an exemplary embodiment, a similar approach may be used to generate a plurality of trips based on the one or more stop events.

Further, the trip data may be generated based on the stop event labelled with the non-traffic label. In this regard, dwell time data and travel time data may be determined based on the analysis of the generated cluster corresponding to the stop event. Accordingly, the trip data associated with the first trip and/or the second trip may include information indicative of at least the dwell time associated with the first destination location and/or second destination location of the first trip and/or the second trip, and the departure time associated with the first trip and/or the second trip. In an example, the dwell time may indicate an operation of standstill at the location of the stop event. Specifically, the dwell time may be indicative of a determined stop time period associated with the stop event. In another example, the departure time may indicate an operation of reaching a destination location from a source location or an operation of traversing the corresponding trip from the origination location to the destination location. In particular, the departure time of the first trip may be indicative of the time range in which the vehicle reached the first destination location from its the first origin location.

In one embodiment, to determine the departure time data for the first trip, the system 102 may be configured to determine a first datapoint of the sub-trajectory associated with the first trip and a last datapoint of the sub-trajectory associated with the first trip. The first datapoint may be determined based on the timestamp 110C of the first datapoint is less among other datapoints associated with the sub-trajectory, and the last datapoint may be determined based on the timestamp 110C of the last datapoint is greater among other datapoints associated with the sub-trajectory. Furter, a time difference between the timestamp 110C of the first datapoint of the sub-trajectory and the timestamp 110C of the last datapoint of the sub-trajectory may be calculated. Consider an example, where the first datapoint may be associated with the timestamp T1 ‘01:05:00’ and the last datapoint may be associated with the timestamp T2 ‘01:15:00’. Continuing with the present example, the time difference may be calculated as Time difference=T2−T1=‘01:15:00’−‘01:05:00’=10 minutes. Further, the calculated time difference (e.g. 10 minutes) may be represented as the departure time data associated with the first trip.

The output module 202F of the processor 202 may be configured to output at least the information associated with the generated cluster to the labelling module 202D. The labelling module 202D is further configured to associate the stop event with the traffic label or the non-traffic label based on the reference location associated with the corresponding cluster. Specifically, the reference location of the stop event may be determined based on a center datapoint from the set of datapoints corresponding the cluster associated with the stop event. Further, the stop event may be associated with the traffic label or the non-traffic label based on the reference location of the stop event. Further, the trip data generation module 202E is configured to generate the trip data based on the stop event associated with the non-traffic label. Further, the output module 202F may be configured to output the generated trip data, for example, to update the map database 106B, generate navigation recommendations, and/or perform trip-related analytics. For example, the trajectory may include datapoints corresponding to one or more POI locations. Accordingly, the trip data is indicative of trips incidents information associated with datapoints corresponding to each of the POI locations.

The memory 204 of the system 102 may be configured to store the ML model 108 and the trajectory data 110. The ML model 108 may include electronic data, such as, for example, a software program, code of the software program, libraries, applications, scripts, or other logic or instructions for execution by a processing device, such as the system 102. The ML model 108 may include code and routines configured to enable a computing device, such as the system 102 to perform one or more operations for generating the one or more clusters. The application of the ML model 108 on the plurality of datapoints may generate the one or more clusters. Additionally, or alternatively, ML model 108 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 108 may be implemented using a combination of hardware and software.

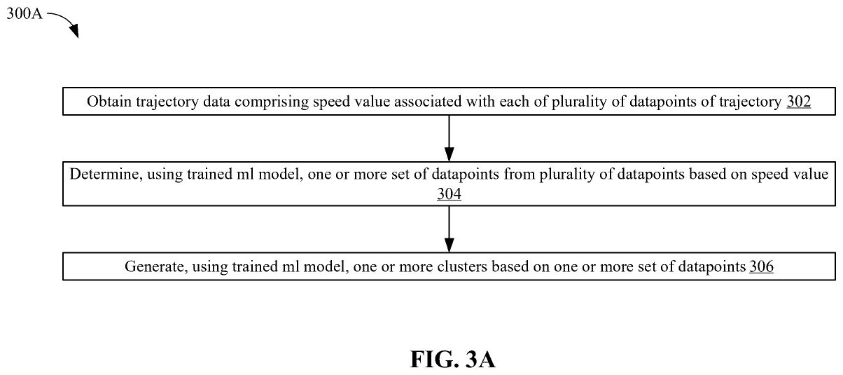

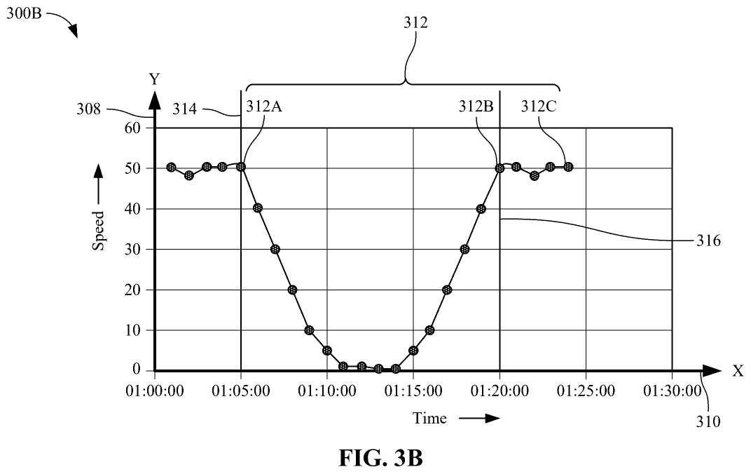

FIG. 3A illustrates exemplary flowchart 300A of a method for generating one or more clusters corresponding to one or more stop events using the ML model 108, in accordance with an embodiment of the disclosure. FIG. 3A is explained in conjunction with elements from FIG. 1, and FIG. 2. With reference to FIG. 3A, there is shown the block diagram 300A that illustrates exemplary operations from 302 to 306, as described herein. The exemplary operations illustrated in the block diagram 300A may start at 302 and may be performed by any computing system, apparatus, or device, such as by the system 102 of FIG. 1 or the processor 202 of FIG. 2. Although illustrated with discrete blocks, the exemplary operations associated with one or more blocks of the block diagram 300A may be divided into additional blocks, combined into fewer blocks, or eliminated, depending on the particular implementation.

In one embodiment, consider an example where a first user of a first vehicle is planning to travel from an origin location to a destination location. To fulfill the plan, the first user may request the system 102 to generate the trip data associated with trajectory including the origin location and the destination location. The request may be transmitted to the system 102 via a user device associated with the first user. The request may include, but is not limited to, a voice input, a touch screen input, a button input, or the like. In one embodiment, the user device may be equipped in the first vehicle or may be a personal device, such as, but not limited to, a mobile device, a laptop, or a tablet of the first user. In one embodiment, the system 102 may be configured to generate the trip data associated with trajectory based on the request from the first user. In another embodiment, the system 102 may be configured to determine a current location of the first vehicle. Further, the system 102 may be configured to generate the trip data associated with the trajectory based on the current location of the first vehicle is indicative of a location on the trajectory. In some embodiments, a second user which is an administrator of the system 102 may transmit, via a user device associated with the second user, a trigger to the system 102 to initiate the process of generating the trip data.

At 302, the trajectory data 110 may be obtained. In an embodiment, the system 102 may be configured to obtain, from the one or more sources 104, the trajectory data 110 associated with the trajectory of the vehicle. The details about the one or more sources 104 are provided in FIG. 1. The trajectory may be the pathway traveled by the vehicle in the time duration of, for example, but not limited to, 20 minutes before a current time, 30 minutes before the current time, and the like. Examples of the current time may include, but not limited to, 07 hours: 30 minutes: 52 seconds, 13 hours: 20 minutes: 60 seconds, and the like. To ease the travelling of the first vehicle on the trajectory, the system 102 may be configured to obtain the trajectory data 110 associated with the vehicle(s) that previously travelled on the same trajectory. The trajectory may include the plurality of datapoints, and the trajectory data may include the speed value 110A associated with each datapoint of the plurality of datapoints, the location data 110B associated with each datapoint of the plurality of datapoints, and the timestamp 110C associated with each datapoint of the plurality of datapoints. Each datapoint of the plurality of datapoints is indicative of the corresponding speed of the vehicle when the vehicle travelled on the trajectory, the corresponding location of the vehicle when the vehicle travelled on the trajectory, and the corresponding timestamp of the vehicle when the vehicle travelled on the trajectory. Exemplary trajectory data 110 is shown in Table T1.

TABLE T1
Trajectory Data 110 Associated with Trajectory

| The Plurality | Speed Value | Location Data | |
|---|---|---|---|
| of Datapoint | 110A | 110B | Timestamp 110C |
| P₁ | 62 km/h | 121.594800°N, | 2023-12-25T00:00:10Z |
| | | 31.200000°W | |
| P₂ | 80 km/h | 121.583500°N, | 2023-12-25T00:01:11Z |
| | | 31.198000°W | |
| . . . | . . . | . . . | . . . |
| Pₙ | 82 km/h | 121.547800°N, | 2023-12-25T00:12:56Z |
| | | 31.190500°W | |

In one embodiment, the system 102 may be configured to store the trajectory data 110 in the memory 204 as represented in the Table T1. As shown in T1, at timestamp 2023-12-25T00:00:10Z, the location of the vehicle may be 121. 594800°N, 31.200000°W and the speed of the vehicle may be 62 km/h. Similarly, each datapoint of the plurality of datapoints is indicative of a respective speed, a respective location, and a respective timestamp of the vehicle.

In an exemplary embodiment, the speed value 110A of each datapoint of the plurality of datapoints may correspond to a speed at which the vehicle was travelling or crossed a location corresponding to the datapoint is captured. Examples of the speed value 110A may include, 10 kilometers per hour (kmph), 30 kmph, or 50 kmph, or the like. The speed value 110A may be measured using a speed sensor associated with the vehicle. The speed sensors may be, for example, but are not limited to, a magneto-resistive sensor, a bipolar sensor, a monopolar sensor, and a mechanical speed sensor. The speed value 110A of the vehicle may be further determined by using radar guns, stopwatches, and GPS tracking devices. For instance, in the context of Intelligent Speed Assistance (ISA) systems, speed value 110A capture may be crucial for ensuring that the system may accurately determine a current speed limit and alert or prevent drivers from exceeding it.

In another exemplary embodiment, the location data 110B of each datapoint of the plurality of datapoints may correspond to a latitude and a longitude positioning of the vehicle when the corresponding datapoint is captured. Examples of the location data 110B at the corresponding datapoint may include, but not limited to, 39 degrees North Pole (°N), 77 degrees West Pole (° W), and 40.7128°N, 74.0060° W. The location data 110B may be captured using positioning sensors such as, but not limited to, a Global Positioning system (GPS) sensor, an Inertial Measurement Unit (IMU) sensor, a Radio Frequency Identification (RFID) sensor, and a Light Detection and Ranging (LIDAR) sensor.

In yet another embodiment, the timestamp 110C of each datapoint of the plurality of datapoints may correspond to a timestamp at which the corresponding datapoint was captured. Example of the timestamp 110C of the corresponding datapoint may include, but not limited to, 2024-06-11T15:30:45Z. Where ‘2024 Jun. 11’ is indicative of a date (year-month-day), ‘T’ is used to separate a time from the data, ‘15:30:45’ is indicative of the time (hours-minutes-seconds), and ‘Z’ indicates that the time is in Coordinated Universal Time (UTC).

In an embodiment, the system 102 may be further configured to pre-process the trajectory data 110 for further processing. The pre-processing may include, but is not limited to, filtering redundance, removal of abnormality, filling missing values. In one example, the trajectory data 110 may include redundant data, for example, two identical timestamps in a sequence. This redundant data may be removed in the pre-processing to avoid inaccurate results in further processing of the trajectory data 110. In another example, the trajectory data 110 may include errors such as the speed value 110A indicating a negative value or the location data 110B indicating an incorrect location. These errors may cause inaccurate processing of the trajectory data 110. To avoid the cause, the system 102 may clean the trajectory data 110 by removing such erroneous datapoints. In yet another example, the trajectory data 110 may include missing or null values. These missing or null values may be replaced with appropriate data values to avoid inaccuracies in further processing of the trajectory data 110.

Further, the system 102 may be configured to input the trajectory data 110 to the trained ML model 108. The ML model 108 is trained to partition the plurality of datapoints into the one or more stop events. The ML model 108 may partition the plurality of datapoints based on the speed value 110A associated with each datapoint of the plurality of datapoints.

In an embodiment, the trajectory may include the one or more stop events. Each stop event of the one or more stop events may be indicative of an event when the vehicle stopped at a location on the trajectory. For example, the vehicle may stop at a signalized intersection, a non-signalized intersection, or on the road segment between the road segments due to the traffic. In another example, the vehicle may stop at the POI indicative of a destination location of a trip or an origin location of the trip associated with the vehicle.

In an embodiment, the ML model 108 is configured to identify the one or more stop events on the trajectory. To identify the one or more stop events, the ML model 108 is trained to generate the one or more cluster by partitioning the plurality of datapoints based on the speed value 110A. Each cluster of the one or more clusters is corresponds to a stop event of the one or more stop events.

At 304, the one or more set of datapoints from the plurality of datapoints are determined. In an embodiment, the system 102 may be configured to determine, using the ML model 108, the one or more set of datapoints of the plurality of datapoints based on the speed value 110A. For example, where the trajectory associated with the trajectory data 110 is including the plurality of datapoints. Each datapoint of the plurality of datapoints may represent associated information as datapoint (speed value 110A, location data 110B, timestamp 110C). According to the present example, the information associated with the plurality of datapoints may be represented as P₁ (62, 21. 594800°N, 31.200000° W, 2023-12-25T00:00:10Z), P₂ (80, 121.583500° N, 31.198000° W, 2023-12-25T00:01:11Z), Pₙ (2, 121.547800° N, 31.190500° W, 2023-12-25T00:12:56Z).

In one embodiment, to generate a cluster of the one or more clusters, the ML model 108 may be configured to determine whether the speed value 110A associated with each datapoint of the plurality of datapoints is zero or less than a threshold. The threshold may be, for example, but not limited to, 3 km/h, or 5 km/h. based on identifying a set of data points to be less than the threshold, the set of data points are clustered to correspond to a stop event.

At 306, the one or more clusters may be generated. In an embodiment, the system 102 may be configured to generate, using the ML model 108, one or more clusters based on one or more set of datapoints. In an embodiment, the ML model 108 may be configured to generate the cluster including at least one datapoint of the plurality of datapoints based on the determination that the speed value 110A associated with each datapoint of the at least one datapoint is less than the threshold. In an embodiment, considering a count of the plurality of datapoints is N, the ML model 108 may be configured to perform N number of iterations to compare the speed value 110A of each datapoint of the plurality of datapoints. The N number may be any integer value, for example, but not limited to, 1, 2, 10, 100, or the like. Considering the N is equal to 5, in a first iteration, based on the determination that the speed value 110A of a first datapoint of the plurality of datapoints is less than the threshold, the ML model 108 may be configured to include the first datapoint in a first cluster of the one or more cluster. In a second iteration, based on the determination that the speed value 110A of a second datapoint of the plurality of datapoints is less than the threshold, the ML model 108 may be configured to include the second datapoint in the first cluster. In the third iteration, based on the determination that the speed value 110A of a third datapoint of the plurality of datapoints is greater than the threshold, the ML model 108 may be configured to skip the third datapoint and further moves to a next iteration. In a fourth iteration, based on the determination that the speed value 110A of a fourth datapoint of the plurality of datapoints is less than the threshold, the ML model 108 may be configured to include the fourth datapoint in a second cluster of the one or more cluster. In a fifth iteration, based on the determination that the speed value 110A of a fifth datapoint of the plurality of datapoints is less than the threshold, the ML model 108 may be configured to include the fifth datapoint in the second cluster. In this manner, the ML model 108 may be configured to determine the at least one datapoint for each cluster of the one or more clusters.

In another embodiment, the ML model 108 may implement an algorithm that may be, for example, but not limited to, K-means algorithm. The K-means algorithm may be a centroid-based clustering algorithm that may aim to partition the plurality of datapoints into K clusters (such as the one or more clusters) based on their similarity to cluster centroids. In an exemplary embodiment, the ML model 108 may be configured to determine at least one datapoint of the plurality of datapoints indicative of the speed value 110A equal to 0. Further, the ML model 108 may be configured to establish the at least one datapoint as the cluster centroids. It may further involve iteratively assigning datapoints (such as the plurality of datapoints) to a nearest centroid of the cluster centroids and updating the cluster centroids to minimize the sum of distances within the one or more clusters.

The system 102 may be configured to generate the one or more clusters based on the application of the ML model 108 on the plurality of datapoints. Each datapoint with a speed value at 0 km/h or less than the threshold may be assigned within a cluster of the one or more clusters. In an embodiment, the cluster of the one or more clusters may include a set of datapoints that may be similar to each other based on their relation to surrounding datapoints. Further, clustering is a technique that may be used to group objects or datapoints that may share similarities, allowing for the identification of patterns, relationships, and structures within complex datasets. The one or more clusters may be formed based on the inherent characteristics of the data, without the need for labelled information, making it an essential tool for exploratory data analysis and pattern recognition in various fields.

In an exemplary embodiment, the number of the one or more clusters, K, must be specified by the second user, who may be the administrator of the system 102. The selection of the right value of ‘K’ may be crucial for the performance of the K-means algorithm. In another exemplary embodiment, the optimal value of K may be determined by using an elbow method. The elbow method may plot the sum of squared errors (SSE) for different values of K and look for the point where the SSE starts to level off, indicating the optimal number of the one or more clusters.

In an exemplary embodiment, the system 102 may be configured to receive an input associated with a count of the one or more clusters from a user device associated with the second user. Further, the system 102 may be configured to generate the one or more clusters based on the application of the ML model 108 based on the speed value 110A associated with each datapoint of the plurality of datapoints and the received input. For example, the second user may interact with system 102 through the user device to provide the input associated with the count of the one or more clusters that may be denoted as the value of ‘K’ in the K-means clustering algorithm. The second user may input the desired number of the one or more clusters to be generated based on the data and analysis requirements. For example, if the second user inputs K=3, the system 102 may apply the ML model 108 to the plurality of datapoints and outputs three distinct clusters based on the characteristics and patterns identified in the plurality of datapoints allowing for the segmentation of the plurality of datapoints into the specified number of the one or more clusters.

Further, the event data associated with the stop event may be determined. In an embodiment, the system 102 may be configured to determine the event data associated with each stop event of the one or more stop events based on the generated one or more clusters. In an embodiment, the ML model 108 may generate the one or more clusters such that each cluster of the one or more clusters may correspond to a respective stop event of the one or more stop events. For example, a first cluster of the one or more clusters may correspond to a first stop event of the one or more events and may include the at least one datapoint of the plurality of datapoints. The at least one datapoint is used to generate first event data for the respective first stop event. The first event data may include the speed value 110A indicating a speed of the vehicle when the first stop event occurred on the trajectory. The first event data may further include the location data 110B indicating a location of the vehicle when the first stop event occurred on the trajectory. Further, the first event data may include the timestamp indicating a time associated with the vehicle when the first stop event occurred on the trajectory.

FIG. 3B illustrates a graphical representation 300B depicting a cluster of the one or more clusters corresponding to a stop event of the one or more stop events, in accordance with an embodiment of the disclosure. FIG. 3B is explained in conjunction with elements from FIG. 1, FIG. 2, and FIG. 3A. With reference to FIG. 3B, there is shown a graph that depicts the cluster of the one or more clusters corresponding to the stop event of the one or more stop events.

In an embodiment, Y-axis 308 may correspond to the speed value 110A of the vehicle associated with each datapoint of a plurality of datapoints (depicted as datapoints 312A, 312B and 312C, and collectively referred to as the plurality of datapoints 312). Similarly, X-axis 310 may correspond to the timestamp 110C of the vehicle associated with each datapoint of the plurality of datapoints 312. The graphical representation depicts a change in the speed value 110A of the vehicle in association with the timestamp 110C. For example, at the timestamp ‘01:05:00’, the speed of the vehicle is 50 km/h.

In an embodiment, the cluster may include a set of datapoints of the plurality of datapoints 312 based on the determination, by the ML model 108, that the speed value 110A of each datapoint of the set of datapoints is less than the threshold. The set of datapoints may include datapoints from a datapoint 312A to a datapoint 312B. Specifically, the datapoint 312A is the first datapoint of the cluster and the datapoint 312B is the last datapoint of the cluster.

In an exemplary embodiment, the system 102 may be configured to determine a stop time period associated with the cluster. The stop time period may include a first time instance 314 corresponding to the start of the cluster and a second time instance 316 corresponding to the end of the cluster. In one example, the system 102 may be configured to determine the first time instance 314 based on the first datapoint (such as the datapoint 312A) of the cluster. Similarly, the system 102 may be configured to determine the second time instance 316 based on the last datapoint (such as the datapoint 312B) of the cluster. In an example, the first time instance 314 is indicative of the timestamp 110C associated with the first datapoint of the cluster. Similarly, the second time instance 316 is indicative of the timestamp 110C associated with the last datapoint of the cluster.

In an example, the first datapoint may be included in the cluster before an inclusion of other datapoints in the cluster. Similarly, the last datapoint may be included in the cluster after the inclusion of other datapoints in the cluster. In an example, the first datapoint and the last datapoint may be determined based on the timestamp 110C associated with each datapoint of the at least one datapoint of the cluster. Specifically, the first datapoint may be determined based on a determination that a timestamp associated with the first datapoint is less among the at least one datapoint of the cluster. Similarly, the last datapoint may be determined based on a determination that a timestamp associated with the last datapoint is greater among the at least one datapoint of the cluster. For example, the cluster includes the set of datapoints, and each datapoint of the set of datapoints is associated with the timestamp 110C. In this example, the system 102 may be configured to determine the first datapoint of the set of datapoints based on the determination that the timestamp 110C of the first datapoint is less among the set of datapoints. Similarly, the system 102 may be configured to determine the last datapoint of the set of datapoints based on the determination that the timestamp 110C of the last datapoint is greater among the set of datapoints

Further, the system 102 may be configured to determine the stop time period of the stop event based on the determined first datapoint and the last datapoint of the cluster associated with the stop event. In current scenario, based on the first datapoint of the cluster is 312A and the last datapoint of cluster is 312B, the first time instance 314 is indicative of a timestamp ‘01:05:00’ and the second time instance 316 is indicative of a timestamp ‘01:20:00’. Continuing with the present example, based on the first time instance 314 is indicative of the timestamp ‘01:05:00’ and the second time instance 316 is indicative of the timestamp ‘01:20:00’, the stop time period may be determined as a time difference between the timestamp ‘01:05:00’ and the timestamp ‘01:20:00’. In one example, considering the first time instance is ‘T1’ and the second time instance is ‘T2’, the time difference may be calculated as time difference=T2−T1=01:20:00−01:05:00=00:15:00. Accordingly, the calculated time difference as the stop time period is equal to 15 minutes.

In an embodiment, each cluster of the one or more clusters may correspond to a respective stop event of the one or more stop event. The cluster as shown in FIG. 3B may correspond to a particular stop event of the one or more stop events on the trajectory. Further, the system 102 may determine a reference location with which location corresponding to the sop event is associated. In other words, the system 102 may determine whether a location of the stop event corresponding to the datapoints 312A and 312B is associated with a signalized intersection, a non-signalized intersection, a road segment, or a POI.

In an embodiment, the stop event may be associated with the reference location which is the POI. In such embodiments, the system 102 may be configured to associate the stop event with the non-traffic label. Further, the system 102 may be configured to determine dwell time data of the stop event. Considering the stop event associated with the cluster shown in FIG. 3B may be associated with the reference location, which is the POI, the system 102 may be configured to determine the dwell time data associated with the POI. For example, the dwell time data may indicate an amount of time that the vehicle spent at the POI, for example, to visit the POI, pick someone from the POI, drop someone at the POI, or halt at the POI. This may indicate an amount of time that the vehicle was at a standstill, i.e., perform a standstill operation, at the POI. For example, the dwell time data indicative of time spent at the POI may be 15 minutes for the stop event under consideration. Further, the system 102 may be configured to update the map database 106B based on the determined dwell time data associated with the POI. In one example, the map database 106B may include a dwell time associated with the POI. The POI may be, for example, but not limited to, a park, a restaurant, a museum, airport, a hotel, railway station, building, or the like. The dwell time may indicate an average amount of time that vehicles tend to spend at the POI (e.g. at the restaurant). Continuing with the present example, the system 102 may be configured to update, in the map database 106B, the dwell time of the POI based on the determined dwell time data associated with the POI.

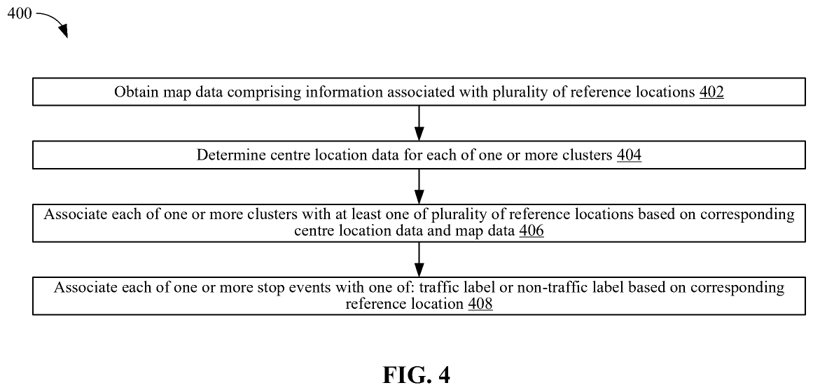

FIG. 4 is a flowchart 400 that illustrates an exemplary method for associating the one or more stop events with a traffic label or a non-traffic label, in accordance with an embodiment of the disclosure. FIG. 4 is explained in conjunction with elements from FIG. 1, FIG. 2, FIG. 3A and FIG. 3B. With reference to FIG. 4, there is shown the flowchart 400. The operations of the exemplary method may be executed by any computing system, for example, by the system 102 of FIG. 1 of the processor 202 of FIG. 2. The operations of the flowchart may start at 402.

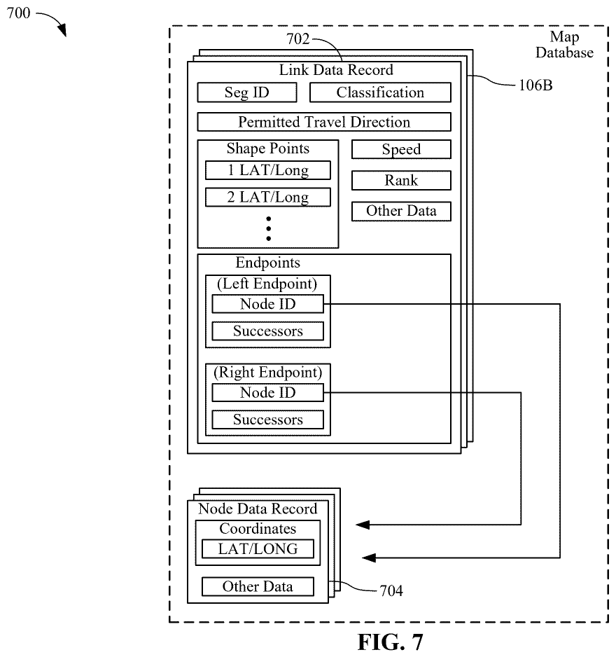

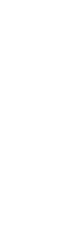

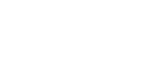

At 402, map data is obtained. In an example, the map data may include information associated with a plurality of reference locations. In an embodiment, the system 102 may be configured to obtain the map data from the map database 106B. The details about the map database 106B are provided in conjunction with, for example, FIG. 1, FIG. 7, FIG. 8, and FIG. 9. In one exemplary embodiment, the map data may be retrieved from a source other than the map database 106B. In an example, the information associated with a plurality of reference locations may include a latitude and a longitude position (e.g. 39.°N, 77°W) of each reference location of the plurality of reference locations. Similarly, each reference location of the plurality of reference locations may be associated with the corresponding information, such as type (e.g., office building, museum, restaurant, hotel, school etc.), operating hours, etc. Additional to the latitude and longitude position, the information may also include an information indicative of a location associated with the latitude and longitude position. For example, the latitude and longitude position as “39.°N, 77°W” may be associated with a location indicative of “Washington, D.C”. In one embodiment, latitude and longitude positions may be associated with their respective locations based on map matching techniques, thereby forming the information associated with the plurality of reference locations.

The map matching techniques may include, but are not limited to, a geometric analysis, a hidden Markov model, a topological relationship, a fuzzy logic model, D-S evidence theory, and a Bayesian inference. The map matching techniques may align a sequence of GPS co-ordinates (e.g. the latitude and longitude positions) with a corresponding road network. The goal of the map matching techniques is to reconstruct and smooth the trajectory by matching each GPS co-ordinate to the closest road segment on a digital road network.

At 404, center location data for each cluster of the one or more clusters may be determined. In an embodiment, the system 102 is configured to determine the center location data for each cluster of the one or more clusters. In an embodiment, to determine the center location data for a cluster of a stop event, the system 102 may be configured to identify a cluster associated with the stop event. In an example, considering the cluster includes a set of datapoints from the plurality of datapoints, the system 102 may be configured to determine a datapoint which is existing in the middle of the set of datapoints. For example, if the set of datapoints may include seven datapoints, the system 102 may determine a fourth datapoint as the middle datapoint. Subsequently, the system 102 may be configured to determine the center location data for the stop event under consideration based on the determined middle datapoint, i.e., a location corresponding to the middle datapoint. In another example, considering the cluster includes a set of datapoints from the plurality of datapoints, the system 102 may be configured to determine a datapoint at which the vehicle speed is detected as 0 km/h. Subsequently, the system 102 may be configured to determine the center location data for the stop event under consideration based on the determined datapoint at which the vehicle speed is 0 km/h.

In an example, the center location data may include location data associated with the middle datapoint or the datapoint with 0 km/h speed. The location data associated with the middle datapoint, or the datapoint may include a latitude and longitude position of the vehicle at the middle datapoint on the trajectory. The center location data may also include a location associated with the latitude and longitude position. The location may correspond to the location of the vehicle at the middle datapoint on the trajectory. For example, based on the latitude and longitude position of the middle datapoint is ‘50° 0′38.20° N, 110° 6′48.32° W’, a corresponding location is ‘Walsh, Alberta, Canada’. Accordingly, the center location data may include the latitude and longitude position of the middle datapoint, and the corresponding location associated with the latitude and longitude position of the middle datapoint. The association of the latitude and longitude position with the corresponding location is performed based on the map matching techniques, as described at operation 402.

At 406, a reference location is associated with each cluster of the one or more clusters. In an embodiment, the system 102 may be configured to associate each cluster of the one or more clusters with at least one reference location of the plurality of reference locations based on the corresponding center location data and the map data. The center location data of a cluster of the one or more clusters may include a latitude and longitude position and a corresponding location associated with the latitude and longitude position. For example, based on a latitude and longitude position, for example, ‘32° 08′59.96°N, 110° 50′09.03° W’, of the center location data, a corresponding location, for example, ‘Tucson, Arizona, United States of America (USA)’, is associated. Further, the information retrieved from the map data also includes a latitude and a longitude position and a corresponding location associated with each reference location of the plurality of reference locations. The plurality of reference locations may include at least one of the POI, the signalized intersection, the non-signalized intersection, or the road segment.

To associate a cluster with a reference location of the plurality of reference locations, the system 102 may be configured to compare the location included in the center location data of the cluster with the location included in the information of each reference location of the plurality of reference locations in the map data. For example, considering the location of the center location data is matched to a location of a signalized intersection in the map data based on the comparison, the system 102 may be configured to associate the cluster to the reference location which is the signalized intersection. In another example, considering the location included in the center location data of the cluster is matched to a location of the non-signalized intersection in the map data, the system 102 may be configured to associate the cluster to the reference location which is the non-signalized intersection. In yet another example, considering the location of the center location data is matched to a location of the road segment between road segments in the map data, the system 102 may be configured to associate the cluster to the reference location which is the road segment. In yet another example, considering the location of the center location data is matched to a location of the POI in the map data, the system 102 may be configured to associate the cluster to the reference location which is the POI. In another embodiment, any location other than the signalized intersection, non-signalized intersection, or the road segment may be considered as the POI.

At 408, the traffic label or the non-traffic label may be associated with each stop event of the one or more stop events. In an embodiment, the system 102 may be configured to associate each stop event of the one or more stop events with a label including the traffic label or the non-traffic label based on the corresponding reference location. In an embodiment, to associate a stop event of the one or more stop events with the label, the system 102 may be configured to determine whether the reference location of the stop event corresponds to the signalized intersection, the non-signalized intersection, the POI, or the road segment. Further, based on the determination that the reference location of the stop event corresponds to the signalized intersection, the non-signalized intersection, or the road segment, the system 102 may be configured to associate the stop event with the traffic label. Similarly, based on the determination that the reference location of the stop event corresponds to the POI or any other location that does not correspond to a signal or a location on a rod segment, the system 102 may be configured to associate the stop event with the non-traffic label. For example, when the reference location of the stop event corresponds to a location on the road segment, say in the middle of the road segment, the system 102 may be configured to associate the stop event with the traffic label. In another example, when the reference location of the stop event corresponds to the POI, the system 102 may be configured to associate the stop event with the non-traffic label.

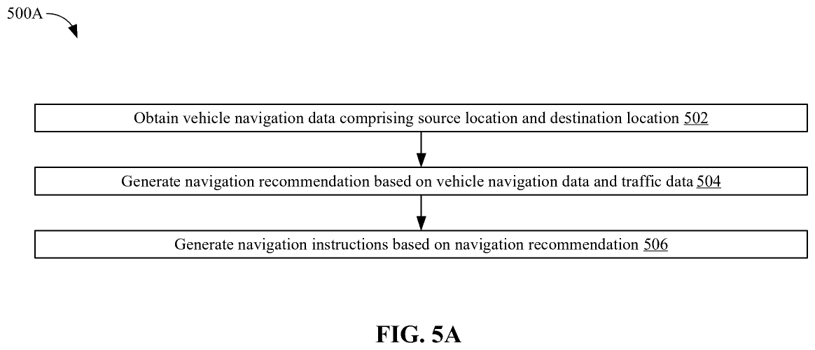

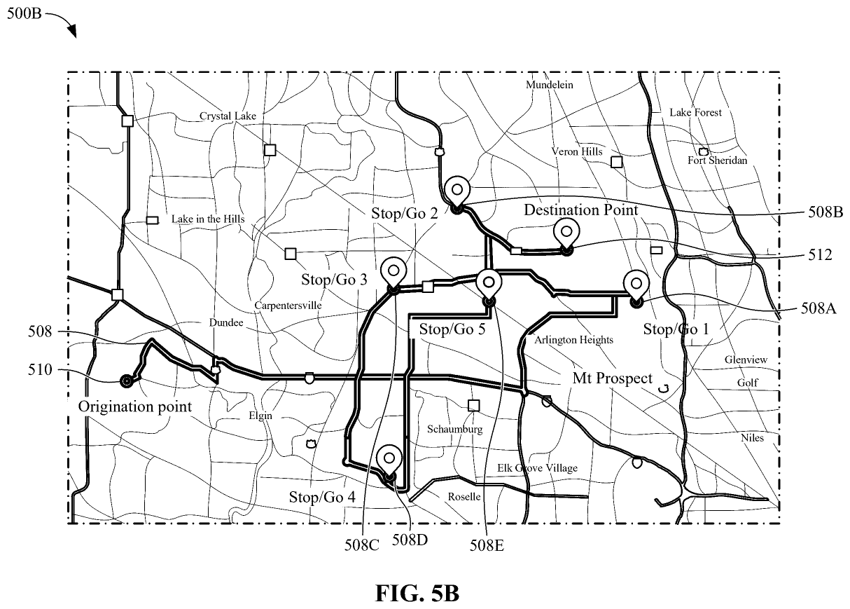

FIG. 5A is a flowchart 500A that illustrates an exemplary method for generating navigation instructions, in accordance with an embodiment of the disclosure. FIG. 5A is explained in conjunction with elements from FIG. 1, FIG. 2, FIG. 3A, FIG. 3B, and FIG. 4. With reference to FIG. 5A, there is shown the flowchart 500A. The operations of the exemplary method may be executed by any computing system, for example, by the system 102 of FIG. 1 of the processor 202 of FIG. 2. The operations of the flowchart may start at 502.

At 502, vehicle navigation data including source location and destination location may be obtained. In an embodiment, the system 102 may be configured to obtain the vehicle navigation data including the source location and the destination location from a user, such as via a user device or a device onboard a vehicle. In an example, a first user may transmit, via the user device associated with the first user, vehicle navigation data including the source location and the destination location to the system 102. In some embodiments, the vehicle navigation data may be automatically transmitted to the system 102 based on a determination that the first user is travelling to the destination location. In another embodiment, the system 102 may be configured to obtain the vehicle navigation data including the source location and the destination location from the map database 106B.

At 504, navigation recommendation based on the vehicle navigation data and the trip data may be generated. In an embodiment, the system 102 may be configured to generate the navigation recommendation based on the vehicle navigation data and the trip data. In an example, based on the source location and the destination location, the system 102 may be configured to identify at least one trajectory for travelling from the source location to the destination location.

In one embodiment, the system 102 may be configured to generate the trip data based on the identified at least one trajectory. For example, the system 102 may be configured to retrieve trajectory data of vehicles that have travelled on the identified trajectory for the first user. Such trajectory data may correspond to one or more vehicles that have previously traversed the identified trajectory. Further, the system 102 may be configured to determine one or more stop events identified for the at least one trajectory and determine a label for each of the one or more stop events identified. Based on stop events associated with the non-traffic label, the trip data may be generated for the trajectory between the source location and the destination location. Such traffic data may then be used to generate navigation recommendation for the first vehicle of the first user. The navigation recommendation may indicate, for example, a fastest route for travelling from the origin location to the source location

For example, based on the dwell time data associated with a destination location of a trip, and/or the departure time data associated with a trip that may be a part of the trajectory. In this manner, trip data may be generated for each possible route between the origin location and the source location. Furter, the navigation recommendation may be generated based on comparing the trip data for each possible route to identify fastest route from the all possible routes.

In an embodiment, based on the destination location of the first trip is matched to the destination location of the vehicle navigation information, the system 102 may be configured to generate the navigation recommendation based on the dwell time data associated with the destination location of the first trip to the first user via the user device. The dwell time data may be indicative of the time range in which the vehicle(s) previously stopped at the destination location. The time range may be for example, 10 minutes, 12 minutes, and the like. Consideration of the dwell time data associated with the destination location may help the first user decide about visiting the destination location. For example, if the destination location is corresponding to a restaurant, and the time range in which the vehicle(s) previously stopped at the restaurant is lower than a threshold, for example, 8 minutes, then it is expected that the restaurant may not be appropriate of visiting.

In another example, based on the time range in which the vehicle(s) stopped at the restaurant is greater than the threshold, the system 102 may be configured to recommend the restaurant to the first user by generating and displaying the navigation recommendation on the user device associated with the first user. In one example, the navigation recommendation may be a message displayed on the user device to notify the first user that the restaurant is suitable for visiting.

In another embodiment, based on the origination location and the destination location of the second trip is matched to the origination location and the destination location of the vehicle navigation information, the system 102 may be configured to output the departure time data associated with the second trip to the first user via the user device. The departure time data may be indicative of a time range in which the vehicle(s) reached the destination location from the origination location. The time range may be for example, 30 minutes, 25 minutes, and the like. Consideration of the departure time data associated with the second trip may help the first user decide about taking the second trip. For example, if the origination location is corresponding to a home location, the destination location is corresponding to an office location, and the time range in which the vehicle reached to the office location from the home location using the sub-trajectory associated with the second trip is greater than a time range associated with another trip, then it is expected that use of the second trip to reach destination location (e.g. office location) may not be appropriate.

Further, the system 102 is configured to generate a navigation recommendation based on the vehicle navigation data and the trip data. For example, based on the time range in which the vehicle(s) reached the office location from the home location using the sub-trajectory associated with the second trip is less than the time range associated with the other trip, the system 102 may be configured to recommend, to the first user, the sub-trajectory associated with the second trip to reach the office location by generating and displaying the navigation recommendation on the user device associated with the first user. In one example, the navigation recommendation may be a message displayed on the user device to notify the first user that the sub-trajectory associated with the second trip is suitable for reaching the office location from home location.

At 506, navigation instruction based on the navigation recommendation and the trip data may be generated. In an embodiment, the system 102 may be configured to generate the navigation instructions based on the navigation recommendation. For example, the system 102 may be further configured to generate navigation instructions for the first user to reach the destination location. The navigation instructions may include instructions to stay on the trajectory corresponding to the fastest route.

In this manner, travel experience of the users may be enhanced by generating trip data associated with the trajectory, making the users take decisions based on the trip incidents included in the trip data. In an exemplary embodiment, the system 102 may help the users save time and reduce travel stress by generating and displaying most efficient routes, congested areas, and optimal departure times, on the user devices. Further, the trip data may also be used to help users save on fuel costs by suggesting more fuel-efficient routes. Furthermore, efficient route planning based on the trip data may also lead to reduced vehicle emissions by minimizing idling times and unnecessary detours, contributing to a lower carbon footprint.

FIG. 5B is a schematic diagram 500B of a trajectory 508 of a vehicle, in accordance with an embodiment of the disclosure. FIG. 5B is explained in conjunction with elements from FIG. 1, FIG. 2, FIG. 3A, FIG. 3B, FIG. 4, and FIG. 5A. With reference to FIG. 5B, there is shown the trajectory 508 associated with the vehicle. The trajectory 508 may include a start point 510 and an end point 512. The trajectory 508 may further include one or more stop events such as a stop event 508A, a stop event 508B, a stop event 508C, a stop event 508D, and a stop event 508E.

In an embodiment, the trajectory 508 may be a pathway travelled by the vehicle for a time duration of, for example, but not limited to, 5 minutes, 10 minutes, 1 hour, and the like. In one example, the trajectory 508 may be a part of another trajectory which is longer than the trajectory 508. Accordingly, the start point 510 may be a start of the trajectory 508 and the end point 512 may be an end of the trajectory 508.

In an embodiment, each stop event of the one or more stop events may be determined based on the trajectory data 110 associated with the trajectory 508. The trajectory 508 may include the plurality of datapoints, and the trajectory data 110 may include the speed value 110A associated with each datapoint of the plurality of datapoints, the location data 110B associated with each datapoint of the plurality of datapoints, the timestamp 110C associated with each datapoint of the plurality of datapoints. The details about the determination of the one or more stop events are provided in FIG. 3A and FIG. 3B.

Further, each stop event of the one or more stop events may be associated with a corresponding reference location. The reference location may correspond to one of the POI, the signalized intersection, the non-signalized intersection, or the road segment between the road segments. In one embodiment, the one or more stop events may be associated with the reference location based on the corresponding center location data and the map data. The Details about the association of the one or more stop events with the reference location are provided in FIG. 4.

Further, each stop event of the one or more stop events may be associated with the label. The label may be the traffic label or the non-traffic label. In one embodiment, the one or more stop events may be associated with the label based on the corresponding reference location. The Details about the association of the one or more stop events with the traffic label or the non-traffic label are provided in FIG. 4.

In one example, each of the stop event 508A, and the stop event 508B may be associated with the reference location, which is indicative of the POI. In such example, the system 102 may be configured to determine the dwell time data for each of the stop event 508A and the 508B. The dwell time data may be indicative of the operation of standstill at the POI associated with stop event. Specifically, the dwell time data may indicate a time range in which the vehicle stopped at the POI. The details about the determination of the dwell time data are provided in FIG. 3B and FIG. 4.

In another example, based on each of the stop event 508A and the stop event 508B may be associated with the reference location, which is indicative of the POI, the system 102 may be configured to generate at least the first trip, and the second trip using the stop event 508A, and the stop event 508B. For example, the sub-trajectory occurring before the stop event 508A may be generated as the first trip and the sub-trajectory occurring after the stop event 508A till the stop event 508B may be generated as the second trip. Specifically, the first trip may include a location of the start point 510 as the origination location, and a location of the stop event 508A as the destination location. Similarly, the second trip may include the location of the stop event 508A as the origination location, and a location of the stop event 508B as the destination location. In some embodiments, a similar approach may be used to generate the plurality of trips based on the one or more stop events associated with the non-traffic label. In this manner, the travel experience of the first user may be enhanced by generating trip data associated with the trajectory, making the first user take decisions based on the trip incidents included in the trip data

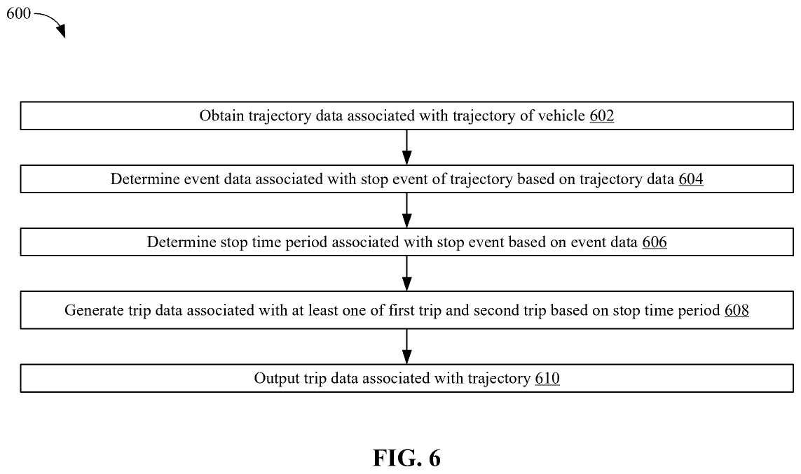

FIG. 6 is a flowchart 600 of an exemplary method for generating trip data based on the trajectory data 110, in accordance with an embodiment of the disclosure. FIG. 6 is explained in conjunction with elements from FIG. 1, FIG. 2, FIG. 3A, FIG. 3B, FIG. 4, FIG. 5A, and FIG. 5B. With reference to FIG. 6, there is shown the flowchart 600. The operations of the exemplary method may be executed by any computing system, for example, by the system 102 of FIG. 1 or the processor 202 of FIG. 2. The operations of the flowchart 600 may start at 602.

At 602, the trajectory data 110 associated with a trajectory of a vehicle may be obtained. In an embodiment, the one or more processors 202 may be configured to obtain the trajectory data 110 associated with the trajectory of the vehicle, the trajectory data 110 may include the speed value 110A associated with each datapoint of the plurality of datapoints, the location data 110B associated with each datapoint of the plurality of datapoints, the timestamp 110C associated with each datapoint of the plurality of datapoints. Details about the trajectory data 110 are provided in FIG. 1 and FIG. 3A.

At 604, event data associated with a stop event of the trajectory may be determined based on the trajectory data 110. In an embodiment, the one or more processors 202 may be configured to identify one or more stop events by clustering the plurality of datapoints based on corresponding speed values. For example, a set of datapoints from the plurality of datapoints having corresponding speed value less than the threshold may be grouped in a cluster. Further, this cluster may indicate a stop event in the trajectory. In this manner, various stop events in the trajectory are identified. Based on the identified stop event, corresponding information is retrieved to generate the event data. For example, information (such as speed data, location data, timestamp data) associated with each datapoint of each of the set of datapoints corresponding to each cluster of the clusters may be retrieved to generate the event data for the one or more stop events. In one embodiment, the ML model 108 may be configured to generate the one or more clusters such that each cluster of the one or more clusters may correspond to a respective stop event of the one or more stop events. Details about the event data are provided in FIGS. 1 and 3A.

At 606, a stop time period associated with the stop event may be determined based on the event data. In an embodiment, the one or more processors 202 may be configured to determine the stop time period associated with the stop event based on the event data. In an example, the stop time period is indicative of the time range in which the vehicle stopped at the specific location of the stop event on the trajectory. The stop time period may include the first time instance corresponding to the start of the stop event and the second time instance corresponding to the end of the stop event. Details about the stop time period determination are provided in FIG. 1, FIG. 3A, and FIG. 4.

At 608, the trip data associated with at least one of the first trip and the second trip may be generated based on the stop time period. In an embodiment, the one or more processors 202 may be configured to generate the trip data associated with the first trip and/or the second trip based on the stop time period. In one embodiment, the system 102 may be configured to generate the trip data based on the stop time period of the stop event associated with the non-traffic label. The trip data may include at least the dwell time data associated with the stop event, and the departure time data associated with the stop event. Details about the generation of the trip data are provided in FIG. 1 and FIG. 4.

At 610, the generated trip data associated with the trajectory may be output. In an embodiment, the one or more processors may be configured to output the trip data associated with the trajectory. In an embodiment, the generated trip data may be provided to the first user, allowing them to plan their routes more efficiently. In another embodiment, the generated trip data may be provided to a downstream processor for processing the trip data for deriving trip analytics associated with the trajectory. Details about the output of the generated trip data are provided in FIG. 1 and FIG. 5A.

Accordingly, blocks of the flowchart 600 support combinations of means for performing the specified functions and combinations of operations for performing the specified functions. It will also be understood that one or more blocks of the flowchart 600 and can be implemented by special-purpose hardware-based computer systems which perform the specified functions, or combinations of special-purpose hardware and computer instructions.

Alternatively, the system 102 may comprise means for performing each operation of the operations described above. In this regard, according to an example embodiment, examples of means for performing operations may comprise, for example, the processor 202 and/or a device or circuit for executing instructions or executing an algorithm for processing information as described above.

Returning to FIG. 1, in an example embodiment, the system 102 may be onboard the vehicle. The system 102 may be a trip data generation system installed in the vehicle for generating trip data associated with the trajectory of the vehicle. In another example embodiment, the system 102 may be the processing server 106A of the mapping platform 106 and therefore may be co-located with or within the mapping platform 106.

In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, such as from the trajectory data 110, before using the data for further processing, such as before sending the data to the ML model 108 (or to the map database 106B). For example, anonymization of the data may be done by the mapping platform 106.

In an example, the system 102 may be installed in the vehicle and may be configured to obtain trajectory data 110. In an exemplary embodiment, the sensors associated with the vehicle may detect the trajectory data 110. Further, the detected trajectory data 110 may be obtained by the system 102 to generate trip data based on the trajectory data 110.

In some example embodiments, the vehicle may include processing means such as a central processing unit (CPU), storage means such as on-board read-only memory (ROM), and random access memory (RAM), acoustic sensors such as a microphone array, position sensors such as a Global Positioning System (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the vehicle. In some example embodiments, the system 102 may be associated, coupled, or otherwise integrated with the vehicle, such as an advanced driver assistance system (ADAS), a personal navigation device (PND), a portable navigation device, the infotainment system, and/or other devices that may be configured to provide route guidance and navigation-related functions to the user.

In some example embodiments, the vehicle may generate trajectory data 110 that may correspond to the speed value 110A, the location data 110B, and the timestamp 110C associated with the generated data of the vehicle. In accordance with an embodiment, the vehicle may generate the trajectory data 110 in real-time and transmit it to the system 102 to generate the trip data associated with the trajectory of the vehicle. In certain cases, the vehicle may be configured to send updated the trajectory data 110 periodically, for example, every five seconds, every thirty seconds, every minute, and so forth.

The mapping platform 106 may comprise suitable logic, circuitry, and interfaces that may be configured to store one or more map attributes and the trajectory data 110 associated with traffic on link segments and lane segments. The mapping platform 106 may be configured to store and update map data indicating the trip data along with other map attributes, road attributes, and traffic entities, in the map database 106B. The mapping platform 106 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 106 may be collected using a plurality of technologies including, but not limited to drones, sensors, connected cars, cameras, probes, and chipsets. In some embodiments, the mapping platform 106 may be embodied as a chip or chip set. In other words, the mapping platform 106 may comprise one or more physical packages (such as chips) that include materials, components and/or wires on a structural assembly (such as a baseboard).

In some example embodiments, the mapping platform 106 may include the processing server 106A for carrying out the processing functions associated with the mapping platform 106 and the map database 106B for storing map data. In an embodiment, the processing server 106A may include one or more processors configured to process requests received from the system 102. In an alternate embodiment, the processors may fetch the trajectory data 110 and/or map data from the map database 106B and transmit the same to the system 102 in a format suitable for use by the system 102.

Continuing further, the map database 106B may comprise suitable logic, circuitry, and interfaces that may be configured to store the trajectory data 110 and map data, which may be collected from the mage sensor and/or the vehicle traveling on the trajectory. In accordance with an embodiment, such as the trajectory data 110 may be updated in real-time or near real-time such as within a few seconds, a few minutes, or on an hourly basis, to provide accurate and up-to-date the trajectory data 110. The trajectory data 110 may be collected from any sensor that may inform the mapping platform 106 or the map database 106B of features within an environment that is appropriate for traffic-related services. In accordance with an embodiment, the trajectory data 110 may be collected from any sensor that may inform the mapping platform 106 or the map database 106B of features within an environment that is appropriate for mapping. For example, motion sensors, inertia sensors, image capture sensors, proximity sensors, LiDAR sensors, and ultrasonic sensors may be used to collect the trajectory data 110. The gathering of large quantities of crowd-sourced data may facilitate the accurate modeling and mapping of an environment, whether it is a road link or a link within a structure, such as in an interior of a multi-level parking structure.

The map database 106B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 106B may be configured to receive the map data including the road topology and geometry-related attributes related to the road network from external systems, such as one or more of background batch data services, streaming data services, and third-party service providers, via the network 112.

In accordance with an embodiment, the map data stored in the map database 106B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 106B may further store historical probe data for events (such as, but not limited to, traffic incidents, construction activities, scheduled events, and unscheduled events) associated with Point of Interest (POI) data records or other records of the map database 106B.

For example, the data stored in the map database 106B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 106B in a delivery format to produce one or more compiled navigation databases.

In some embodiments, the map database 106B may be a master geographic database configured on the side of the system 102. In accordance with an embodiment, a client-side map database 106B may represent a compiled navigation database that may be used in or with end-user devices to provide navigation instructions based on the trip data, the traffic conditions, speed adjustment, ETAs, and/or map-related functions to navigate through the intersection connected links on the route.

In some embodiments, the map data may be collected by end-user vehicles (such as the vehicle) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 106B.

For an example, the map database 106B may include lane and intersection data records or other data that may represent link in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 106B may additionally include data about places, such as cities, towns, or other communities, and other geographic features such as, but not limited to, bodies of water, and mountain ranges.

In some example embodiments, images received from the image source may be stored within the map database 106B of the mapping platform 106. In certain cases, the mapping platform 106, using the processing server 106A, may suitably process the received images. For example, such processing may include, suitably labeling the images based on corresponding associated lane and/or link, point of interest within the link and/or lane, and other information relating to the respective link and/or lane. Such labeled images may then be stored within the map database 106B as map data.

The ML model 108 may include electronic data, such as, for example, a software program, code of the software program, libraries, applications, scripts, or other logic or instructions for execution by a processing device, such as the system 102. The ML model 108 may include code and routines configured to enable a computing device, such as the system 102 to perform one or more operations for generating trip data based on the trajectory data 110. The application of the ML model 108 on a plurality of datapoints may generate one or more clusters. Additionally, or alternatively, the ML model 108 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 108 may be implemented using a combination of hardware and software.

The system 102 may be communicatively coupled to the mapping platform 106, via the network 112. In an embodiment, the system 102 may be communicatively coupled to other components not shown in FIG. 1 via the network 112. All the components in the network environment 100 may be coupled directly or indirectly to the network 112. The components described in the network environment 100 may be further broken down into more than one component and/or combined together in any suitable arrangement. Further, one or more components may be rearranged, changed, added, and/or removed.

The network 112 may be wired, wireless, or any combination of wired and wireless communication networks, such as cellular, Wi-Fi, internet, local area networks, or the like. In some embodiments, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. Long Term Evolution-Advanced Pro), 5G New Radio networks, International Telecommunication Union (ITU)—International Mobile Telecommunication (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

Returning to FIG. 2, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart city solutions by providing real-time safety distance, real-time warnings, big data analysis, and sensor-based data collection by using the cloud-based mapping system for providing accurate navigation instructions and ensuring driver safety. The I/O interface 206 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 206 may communicate with the system 102 and displays the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the navigation instructions, such as trip data, traffic conditions, traffic congestion value, ETA, routing information, road conditions, driving instructions, etc., on the user equipment or audio or display onboard the vehicles via the I/O interface 206.

The communication interface 208 may comprise input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB) or other mechanisms. In some embodiments, the communication interface 208 may enable communication with a cloud-based network to enable deep learning, such as using the set of ML models 108 (that may be hosted on the cloud-based network).

FIG. 7 illustrates an exemplar record of map data 700 stored in the map database 106B according to one or more example embodiments. FIG. 7 shows a link data record 702 that may be used to store data about one or more of the feature lines. This link data record 702 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 702 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each node of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 106 and its associated map database developer selects one or more shape points along the other-than-straight road portion. Shape point data included in the link data record 702 indicate the position, (e.g., latitude, longitude, and optionally, altitude or elevation) of the selected shape points along the represented link.

Additionally, in the compiled geographic database, such as a copy of the map database 106B, there may also be a node data record 704 for each node. The node data record 704 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 8 shows another exemplar record of map data 800 stored in the map database 106B according to one or more example embodiments. In the FIG. 8, the map data 800 is stored by specifying a road segment data record 802. The road segment data record 802 is configured to represent data that represents a road network. In FIG. 8, the map database 106B contains at least one road segment data record 802 (also referred to as “entity” or “entry”) for each road segment in a geographic region.

The map database 106B that represents the geographic region of FIG. 2 also includes a database record 804 (a node data record 804A and a node data record 804B) (or “entity” or “entry”) for each node associated with the at least one road segment shown by the road segment data record 802. (The terms “nodes” and “segments” represent only one terminology for describing these physical geographic features and other terminology for describing these features is intended to be encompassed within the scope of these concepts). Each of the node data records 804A and the node data record 804B may have associated information (such as “attributes”, “fields”, etc.) that allows identification of the road segment(s) that connect to it and/or its geographic position (e.g., its latitude and longitude coordinates).

FIG. 8 shows some of the components of the road segment data record 802 contained in the map database 106B. The road segment data record 802 includes a segment ID 802A by which the data record can be identified in the map database 106B. Each road segment data record 802 has associated with it information (such as “attributes”, “fields”, etc.) that describes features of the represented road segment. The road segment data record 802 may include data 802B that indicate the restrictions, if any, on the direction of vehicular travel permitted on the represented road segment. The road segment data record 802 includes data 802C that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 802 may also include data 802D indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 802 also includes road grade data 802E that indicate the grade or slope of the road segment. In one embodiment, the road grade data 802E include road grade change points and a corresponding percentage of grade change. Additionally, the road grade data 802E may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 802E includes the road grade change points and an actual road grade value for the portion of the road segment after the road grade change point until the next road grade change point or end node. In a further embodiment, the road grade data 802E includes elevation data at the road grade change points and nodes. In an alternative embodiment, the road grade data 802E is an elevation model which may be used to determine the slope of the road segment.

The road segment data record 802 also includes data 802G providing the geographic coordinates (e.g., the latitude and longitude) of the end points of the represented road segment. In one embodiment, the data 802G are references to the node data records 802 that represent the nodes corresponding to the end points of the represented road segment.

The road segment data record 802 may also include or be associated with other data 802F that refer to various other attributes of the represented road segment. The various attributes associated with a road segment may be included in a single road segment record or may be included in more than one type of record which cross-reference each other. For example, the road segment data record 802 may include data identifying the name or names by which the represented road segment is known, the street address ranges along the represented road segment, and so on.

FIG. 8 also shows some of the components of the node data record 804 contained in the map database 106B. Each node data record of the node data records 804 may have associated information (such as “attributes”, “fields”, etc.) that allows identification of the road segment(s) that connect to it and/or it is geographic position (e.g., its latitude and longitude coordinates). For the embodiment shown in FIG. 8, the node data records 804A and 804B include the latitude and longitude coordinates 804A1 and 804A1 for their nodes. The node data records 804A and 804B may also include other data 804A2 and 804B2 that refer to various other attributes of the nodes.

Thus, the overall data stored in the map database 106B may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 106B in the formats shown in FIG. 7 and FIG. 8 may be combined in a suitable manner to provide these three or more layers of information. In some embodiments, there may be lesser or fewer number of layers of data also possible, without deviating from the scope of the present disclosure.

FIG. 9 illustrates a block diagram 900 of the map database 106B storing map data or geographic data 904 in the form of road segments/links, nodes, and one or more associated attributes as discussed above. Furthermore, attributes may refer to features or data layers associated with the link-node database, such as a High-Definition (HD) lane data layer.

In addition, the map data 904 may also include other kinds of data 906. The other kinds of data 906 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 106B also includes indexes 902. The indexes 902 may include various types of indexes that relate the different types of data to each other or that relate to other aspects of the data contained in the geographic database 106B.

The data stored in the map database 106B in the various formats discussed above may help in providing precise data for high definition mapping applications, autonomous vehicle navigation and guidance, cruise control using ADAS, direction control using accurate vehicle maneuvering and other such services. In some embodiments, the system 102 accesses the map database 106B storing data in the form of various layers and formats depicted in FIG. 7, FIG. 8, and FIG. 9.

Various embodiments of the disclosure may provide a non-transitory computer readable medium having stored thereon computer executable instructions, which when executed by one or more processors (such as the processor 202), cause the one or more processors to carry out operations to operate a system (e.g., the system 102) for generating trip data based on trajectory data. The operations include obtaining trajectory data associated with a trajectory of a vehicle. The operations further include determining event data associated with a stop event of the trajectory based on the trajectory data. Further, the operations include determining a stop time period associated with the stop event based on the event data. The operations further include generating trip data associated with at least one of a first trip, or a second trip based on the stop time period. Further, the operations include outputting the generated trip data associated with the trajectory.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors configured to:
obtain trajectory data associated with a trajectory of a vehicle;
determine event data associated with a stop event of the trajectory based on the trajectory data;
determine a stop time period associated with the stop event based on the event data, wherein the stop time period comprises a first time instance corresponding to a start of the stop event and a second time instance corresponding to an end of the stop event;
generate trip data associated with at least one of: a first trip, or a second trip based on the stop time period, wherein the first trip is associated with a first time period occurring before the first time instance and the second trip is associated with a second time period occurring after the second time instance; and
output the trip data associated with the trajectory.

2. The system of claim 1, wherein the stop event is associated with a non-traffic label.

3. The system of claim 1, wherein the trajectory comprises a plurality of datapoints, and wherein the trajectory data comprises at least one of: a speed value associated with each of the plurality of datapoints, location data associated with each of the plurality of datapoints, and timestamp data associated with each of the plurality of datapoints.

4. The system of claim 3, wherein the one or more processors are further configured to:
input the trajectory data to a trained Machine Learning (ML) model, wherein the ML model is trained to partition the plurality of datapoints based on the speed value and location data; and
generate, using the trained ML model, a cluster based on the speed value and location data, wherein the cluster comprises at least one of the plurality of datapoints, and wherein the cluster corresponds to the stop event.

5. The system of claim 4, wherein the one or more processors are further configured to:
obtain map data comprising information associated with a plurality of reference locations;
determine center location data for the cluster;
associate the cluster with a reference location of the plurality of reference locations based on the center location data and the map data; and
associate the stop event with one of: a traffic label, or a non-traffic label based on the reference location associated with the cluster.

6. The system of claim 5, wherein the reference location associated with the cluster is associated with a geographical landmark, and wherein the one or more processors are further configured to associate the stop event with the non-traffic label based on the geographical landmark.

7. The system of claim 1, wherein the one or more processors are further configured to:
obtain vehicle navigation data comprising a source location and a destination location, wherein at least one of: the source location, or the destination location is associated with at least one of: the first trip, or the second trip; and
generate a navigation recommendation based on the vehicle navigation data and the trip data
generate navigation instructions based on the navigation recommendation.

8. The system of claim 1, wherein the one or more processors are further configured to pre-process the trajectory data to remove one or more anomalies in the trajectory data.

9. The system of claim 1, wherein the one or more processors are further configured to receive the trajectory data from one or more sensors associated with the vehicle, and wherein the one or more sensors comprises at least one of: a Global Navigation Satellite System (GNSS) sensor, or a speed sensor.

10. A method comprising:
obtaining trajectory data associated with a trajectory of a vehicle;
determining event data associated with a stop event of the trajectory based on the trajectory data;
determining a stop time period associated with the stop event based on the event data, wherein the stop time period comprises a first time instance corresponding to a start of the stop event and a second time instance corresponding to an end of the stop event;
generating trip data associated with at least one of: a first trip, or a second trip based on the stop time period, wherein the first trip is associated with a first time period occurring before the first time instance and the second trip is associated with a second time period occurring after the second time instance; and
outputting the trip data associated with the trajectory.

11. The method of claim 10, wherein the stop event is associated with a non-traffic label.

12. The method of claim 10, wherein the trajectory comprises a plurality of datapoints, and wherein the trajectory data comprises at least one of: a speed value associated with each of the plurality of datapoints, location data associated with each of the plurality of datapoints, and timestamp data associated with each of the plurality of datapoints.

13. The method of claim 12, further comprising:
inputting the trajectory data to a trained Machine Learning (ML) model, wherein the ML model is trained to partition the plurality of datapoints based on the speed value and the location data; and
generating, using the trained ML model, a cluster based on the speed value and the location data, wherein the cluster comprises at least one of the plurality of datapoints, and wherein the cluster corresponds to the stop event.

14. The method of claim 13, further comprising:
obtaining map data comprising information associated with a plurality of reference locations;
determining center location data for the cluster;
associating the cluster with a reference location of the plurality of reference locations based on the center location data and the map data; and
associating the stop event with one of: a traffic label, or a non-traffic label based on the reference location associated with the cluster.

15. The method of claim 14, wherein the reference location associated with the cluster is associated with a geographical landmark, and wherein the method further comprising associating the stop event with the non-traffic label based on the geographical landmark.

16. The method of claim 10, further comprising:
obtaining vehicle navigation data comprising a source location and a destination location, wherein at least one of: the source location, or the destination location is associated with at least one of: the first trip, or the second trip; and
generating a navigation recommendation based on the vehicle navigation data and the trip data; and
generating navigation instructions based on the navigation recommendation.

17. The method of claim 10, wherein the method further comprises pre-processing the trajectory data to remove one or more anomalies in the trajectory data.

18. A computer programmable product comprising a non-transitory computer readable medium having stored thereon computer executable instructions, which when executed by one or more processors, cause the one or more processors to carry out operations comprising:
obtaining trajectory data associated with a trajectory of a vehicle;
determining event data associated with a stop event of the trajectory based on the trajectory data;
determining a stop time period associated with the stop event based on the event data, wherein the stop time period comprises a first time instance corresponding to a start of the stop event and a second time instance corresponding to an end of the stop event;
generating trip data associated with at least one of: a first trip, or a second trip based on the stop time period, wherein the first trip is associated with a first time period occurring before the first time instance and the second trip is associated with a second time period occurring after the second time instance; and
outputting the trip data associated with the trajectory.

19. The computer programmable product of claim 18, wherein the trajectory comprises a plurality of datapoints, and wherein the trajectory data comprises at least one of: a speed value associated with each of the plurality of datapoints, location data associated with each of the plurality of datapoints, and timestamp data associated with each of the plurality of datapoints.

20. The computer programmable product of claim 19, wherein the computer executable instructions, which when executed by the one or more processors, cause the one or more processors to:
inputting the trajectory data to a trained Machine Learning (ML) model, wherein the ML model is trained to partition the plurality of datapoints based on the speed value and the location data; and
generating, using the trained ML model, a cluster based on the speed value and the location data, wherein the cluster comprises at least one of the plurality of datapoints, and wherein the cluster corresponds to the stop event.
